(19) United States
(12) Patent Application Publication
(10) Pub. No.: US 2010/0001609 A1
(43) Pub. Date: Jan. 7, 2010

(54) ROTATING ELECTRIC MACHINE

(75) Inventors: Takashi Ishigami, Hitachinaka (JP); Satoshi Kikuchi, Naka (JP); Takashi Naganawa, Kasumigaura (JP); Takashi Yasuhara, Yotsukaido (JP); Yutaka Matsunobu, Mito (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Chiyoda-ku, Tokyo (JP)

(21) Appl. No.: 12/373,011

(22) PCT Filed: Aug. 15, 2006
(86) PCT No.: PCT/JP2006/316038

§ 371 Date: Jan. 8, 2009

(51) Int. Cl. H02K 3/04; H02K 1/16

(52) U.S. Cl. 310/202; 310/207; 310/208

(57) ABSTRACT

An object of the present invention is to provide a compact, high-power rotating electric machine by downsizing coil ends on a distributed-wound stator using rectangular wires in comparison with the conventional one or by enhancing coil heat radiation from the coil ends or slot insertion portions.

A stator (110) comprises a stator core (112), and stator coils (114) inserted into stator slots (112S) formed between a plurality of stator teeth (112T) formed on the stator core, and wound around the stator teeth in the form of distributed winding. Each stator coil (114) includes a plurality of rectangular wires having insulating coating, and the plurality of rectangular wires are inserted into the one stator slot. The direction of arrangement of the plurality of rectangular wires in the stator slot is different from that of the plurality of rectangular wires at both coil ends outside the stator slot.

### TECHNICAL FIELD

The present invention relates to a rotating electric machine such as a motor and a generator. More particularly, the invention relates to a rotating electric machine preferably using rectangular wires as conducting wires for stator coils.

### BACKGROUND ART

There are two types of stator coil windings: concentrated winding in which a wire is wound around each tooth in concentrated manner, and distributed winding in which a wire is wound over a plurality of slots and therefore coils of different phases or the same phase are overlapped each other at coil ends. With a concentrated-wound stator, coil ends can be downsized and therefore this type of stator is effective for downsizing a rotating electric machine and improving its efficiency. However, a rotating magnetic field generated on the inner circumference of the stator is not smoothly distributed resulting in a drawback that noise due to harmonics occurs. With a distributed-wound stator, on the other hand, a rotating magnetic field on the inner circumference of the stator can be approximated to a sine wave, making it possible to reduce noise more than the concentrated-wound stator. However, many coil portions are overlapped each other at coil ends and therefore the coil volume is larger than that of the concentrated-wound stator, making it difficult to downsize a rotating electric machine and improve its efficiency.

It is necessary for a drive main motor used in an electric vehicle to generate high power in spite of a limited mounting space and a limited battery voltage. There is a strong demand for downsizing and higher power at a remarkably high level. As means for meeting this demand, a method is known for increasing the coil occupation ratio in a stator slot by using rectangular copper wires having a rectangular cross section.

A known concentrated-wound stator coil using rectangular wires is disclosed, for example, in Patent Document 1 and Patent Document 2. It is comparatively easy to apply rectangular wires to the concentrated-wound stator because of its simple coil profile.

On the other hand, in the case of the distributed-wound stator coil using rectangular wires, it is necessary to avoid interference at coil ends while maintaining wire arrangements. As means for solving this problem, a two-layer coil is conventionally known (disclosed, for example, in Patent Document 3, Patent Document 4, and Patent Document 5). The two-layer coil is formed such that one coil piece inserted into a slot is disposed on the outer circumferential side of the slot and the other coil piece inserted into a slot is disposed on the inner circumferential side of the slot. Coil ends of adjacent slots are disposed above and below the two coil pieces of coil ends extending from the top to the slots, thus avoiding interference between different coils. The technique described in Patent Document 3 forms rectangular wires in a pine needle shape through bending, inserts the rectangular wires into slots from an axial end face of a stator core, and electrically connects open ends of rectangular conductor pieces protruded from the opposite end face of the stator core to configure a series-wound electric circuit. The techniques described in Patent Document 4 and Patent Document 5 form a coil referred to as “formed coil” conventionally used for medium- and large-size rotating electric machines for many years. The techniques wind a rectangular wire having a self-fusing layer in an oval shape, harden the whole winding, and twist coil ends to form a non-interference shape of the coil ends. Conductors constituting a coil are arranged in the same direction in slots and at the coil ends, and bonded to and in close contact with each other. With these conventional techniques, one coil wire in an electric circuit is associated with one rectangular wire, and the rectangular wires are arranged in the same direction with the same distance therebetween in the stator slots and at the coil ends.
Patent Document 1: JP-A-2000-245092
Patent Document 2: JP-A-2005-204422
Patent Document 3: JP-A-2001-161050
Patent Document 4: JP-A-6-284651
Patent Document 5: JP-A-8-298756

### DISCLOSURE OF THE INVENTION

### Problem to be Solved by the Invention

However, the conventional distributed-wound stator using rectangular wires has a problem that the coil ends are not small enough to downsize a rotating electric machine. Further, the conventional distributed-wound stator using rectangular wires has a problem of insufficient heat radiation from coil ends.

An object of the present invention is to provide a compact, high-power rotating electric machine by downsizing coil ends on a distributed-wound stator using rectangular wires in comparison with the conventional one or by enhancing coil heat radiation from the coil ends or slot insertion portions.

### Means for Solving the Problem

(1) In order to attain the above-mentioned object, the present invention provides a rotating electric machine comprising a stator and a rotor disposed opposing the stator through a gap and held rotatably. The stator comprises a stator core, and stator coils inserted into stator slots formed between a plurality of stator teeth formed on the stator core, and wound around the stator teeth in the form of distributed winding. Each stator coil includes a plurality of rectangular wires having insulating coating, and the plurality of rectangular wires are inserted into the one stator slot. The direction of arrangement of the plurality of rectangular wires in the stator slot is different from that of the plurality of rectangular wires at both coil ends outside the stator slot.

This configuration makes it possible to downsize the coil ends or enhance coil heat radiation from coil ends or slot insertion portion.

(2) The rotating electric machine according to (1) above, wherein, preferably, the plurality of rectangular wires in the stator slot are arranged in the radial direction of the rotating electric machine such that the rectangular wires are in contact with each other, and wherein, preferably, the plurality of rectangular wires at the coil ends are arranged in the circumferential direction of the rotating electric machine such that the rectangular wires are in contact with each other.

(3) The rotating electric machine according to (2) above, wherein the stator slot is preferably a closed slot, and wherein the rectangular wires formed in a U shape are inserted from one end face of the stator slot and then connected with other rectangular wires protruded from an adjacent stator slot at the other end face of the stator slot to form a series wave winding.

(4) The rotating electric machine according to (2) above, wherein the stator slot is preferably an open slot, and wherein the rectangular wires are formed in a predetermined annular shape to configure a formed coil in advance, and the formed coil is inserted from an open portion of the stator slot to form a parallel winding.

(5) The rotating electric machine according to (1) above, wherein, preferably, the plurality of rectangular wires in the stator slot are arranged in the radial direction of the rotating electric machine such that the rectangular wires are in contact with each other, and wherein, preferably, the plurality of rectangular wires at the coil ends are arranged in the axial direction of the rotating electric machine such that the rectangular wires are spaced apart from each other.

(6) The rotating electric machine according to (5) above, wherein the stator slot is preferably a closed slot, and wherein the rectangular wires formed in a U shape are inserted from one end face of the stator slot and then connected with other rectangular wires protruded from an adjacent stator slot at the other end face of the stator slot to form a series wave winding.

(7) The rotating electric machine according to (5) above, wherein the stator slot is preferably an open slot, wherein the rectangular wires are formed in a predetermined annular shape to configure a formed coil in advance, and wherein the formed coil is inserted from an open portion of the stator slot to form a parallel winding.

(8) The rotating electric machine according to (1) above, wherein, preferably, a plurality of rectangular wires are connected in parallel.

(9) The rotating electric machine according to (1) above, wherein, preferably, the stator teeth have the same radial width, and wherein each of the plurality of rectangular wires inserted into the stator slot has the circumferential width, on the side closer to the rotor, smaller than that of a rectangular wire on the side further from the rotor.

(10) The rotating electric machine according to (3) or (6) above, wherein, preferably, the rectangular wires formed in a U shape are provided with a bonded portion, where the plurality of rectangular wires are bonded with each other and inserted into the stator slot.

(11) The rotating electric machine according to (10) above, wherein, preferably, the bonded portion is a resin-mold portion.

(12) The rotating electric machine according to (11) above, wherein, preferably, the bonded portion is disposed integrally with the resin-mold portion and provided with a thick portion for protecting a portion at which coil wires rise from the core end face.

### EFFECT OF THE INVENTION

The present invention makes it possible to downsize the coil ends, on a distributed-wound stator using rectangular coil wires, more than a conventional stator, or improve coil heat radiation from coil ends or slot insertion portions of the stator, thus obtaining a rotating electric machine with downsizing and higher power.

### BRIEF DESCRIPTION OF THE DRAWINGS

FIG. 1 is a cross-sectional view showing the overall configuration of a rotating electric machine according to a first embodiment of the present invention.

FIG. 2 is a cross-sectional view showing the overall configuration of the rotating electric machine according to the first embodiment of the present invention.

FIG. 3 is an expansion plan view showing the configuration of a stator used for the rotating electric machine according to the first embodiment of the present invention.

FIG. 4 is a perspective view showing the configuration of a stator coil used for the rotating electric machine according to the first embodiment of the present invention.

FIG. 5 is a perspective view showing the configuration of an essential part of the stator used for the rotating electric machine according to the first embodiment of the present invention.

FIG. 6 is a perspective view showing the configuration of a stator coil used for a rotating electric machine according to a second embodiment of the present invention.

FIG. 7 is a perspective view showing the configuration of an essential part of a stator used for the rotating electric machine according to the second embodiment of the present invention.

FIG. 8 is a perspective view showing the configuration of a stator coil used for a rotating electric machine according to a third embodiment of the present invention.

FIG. 9 is a perspective view showing the configuration of an essential part of a stator used for the rotating electric machine according to the third embodiment of the present invention.

FIG. 10 is a perspective view showing the configuration of a stator coil used for a rotating electric machine according to a fourth embodiment of the present invention.

FIG. 11 is a perspective view showing the configuration of a stator coil used for a rotating electric machine according to a fifth embodiment of the present invention.

FIG. 12 is a plan view showing the configuration of an essential part of a stator used for the rotating electric machine according to the fifth embodiment of the present invention.

FIG. 13 is a perspective view showing the configuration of a stator coil used for a rotating electric machine according to a sixth embodiment of the present invention.

FIG. 14 is a perspective view showing the configuration of a stator coil used for the rotating electric machine according to the sixth embodiment of the present invention.

FIG. 15 is a perspective view showing the configuration of a stator coil used for a rotating electric machine according to a seventh embodiment of the present invention.

FIG. 16 is a perspective view showing the configuration of a stator coil used for a rotating electric machine according to an eighth embodiment of the present invention. FIG. 17 is a block diagram showing the configuration of a hybrid vehicle mounting the rotating electric machine according to each embodiment of the present invention.

### DESCRIPTION OF NUMERALS

100 . . . Rotating electric machine
110 . . . Stator
112 . . . Stator core
112C . . . Stator core back
112T . . . Stator teeth
112S . . . Stator slot
114 . . . Stator coil
120 . . . Rotator
122 . . . Rotator core
124 . . . Permanent magnet

### BEST MODE FOR CARRYING OUT THE INVENTION

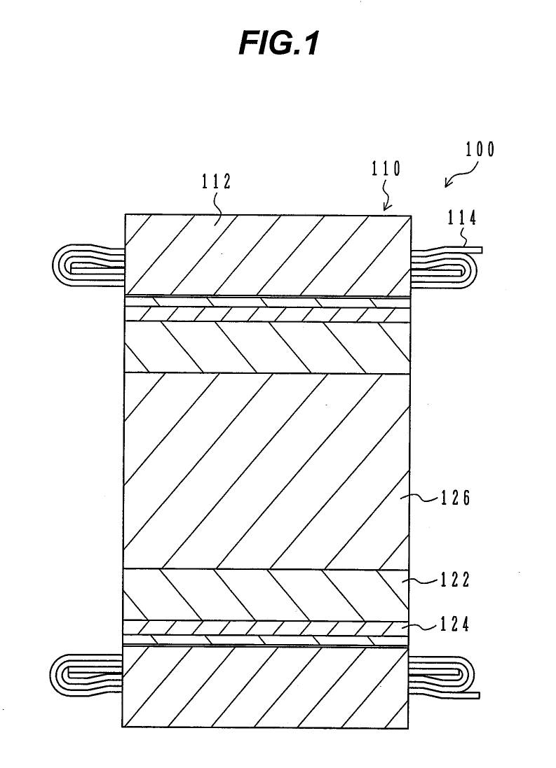

The configuration of a rotating electric machine according to a first embodiment of the present invention will be explained below with reference to FIGS. 1 to 4.

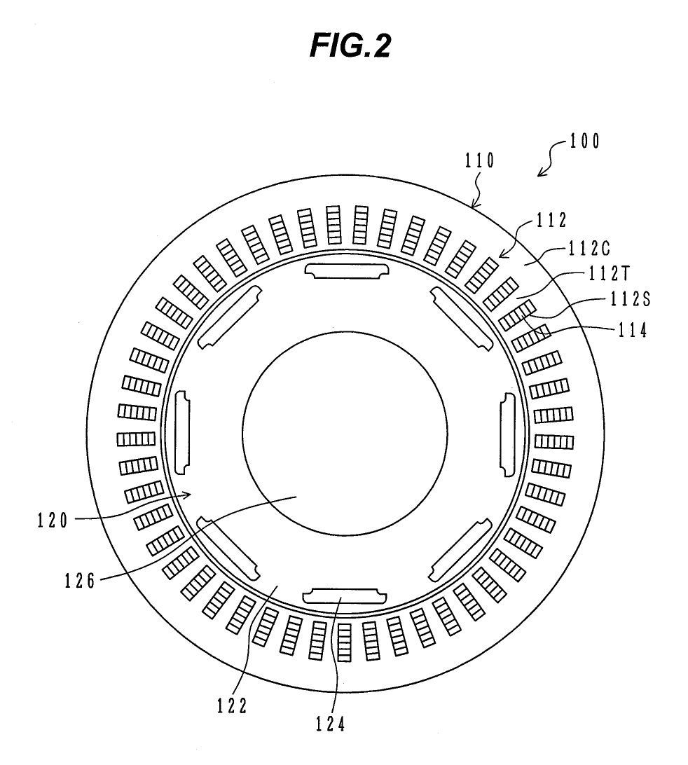

First of all, the overall configuration of the rotating electric machine according to the present embodiment will be explained below with reference to FIGS. 1 and 2.

FIGS. 1 and 2 are cross-sectional views showing the overall configuration of the rotating electric machine according to the first embodiment of the present invention. FIG. 1 shows an axial cross section of the rotating electric machine. FIG. 2 shows a cross section perpendicular to the shaft of the rotating electric machine.

As shown in FIG. 1, a rotating electric machine 100 comprises a stator 110 and a rotor 120. The stator 110 is composed of a stator core 112 and stator coils 114. The stator core 112 has a plurality of slots. The stator coils 114 are inserted into these slots. The rotor 120 is composed of a rotor core 122, a plurality of permanent magnets 124, and a shaft 126. The rotor core 122 includes a hole penetrating in the rotating shaft direction, and the shaft 126 is inserted into this hole. The rotor core 122 includes a plurality of magnet insertion holes provided in the rotating shaft direction, the magnet insertion holes being arranged at circumferentially equal intervals. The plurality of permanent magnets 124 are inserted into the magnet insertion holes.

Although not shown, the stator 100 is attached to the inner circumference of a housing having a cylindrical shape. Front and rear brackets are attached at the front and rear ends of the housing, respectively. A bearing is attached at the center of the front bracket and at the center of the rear bracket. Both ends of the shaft 126 of the rotor 120 are rotatably supported by these bearings. Specifically, the rotor 120 is rotatably disposed on the side inward of the stator 110 such that a predetermined gap is provided therebetween.

As shown in FIG. 2, the stator core 112 is composed of a stator core back 112C and a plurality of stator teeth 112T radially extending to the stator core back 112C. The stator core back 112C and the stator teeth 112T are integrally formed through punch press or the like. A stator slot 112S is formed between adjacent stator teeth 112T. In the present embodiment, the stator is provided with 48 stator slots 112S of closed slot type having a closed shape. Each of the stator coils 114 is wound around each stator tooth 112T in the form of series distributed winding.

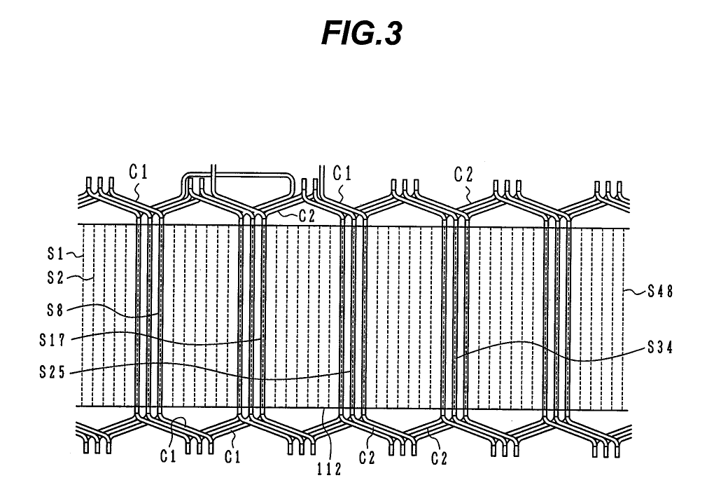

The configuration of a stator used for the rotating electric machine according to the present embodiment will be explained below with reference to FIGS. 3 to 5.

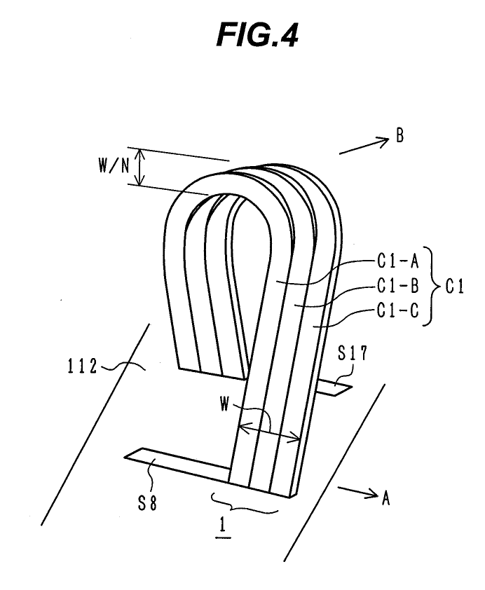

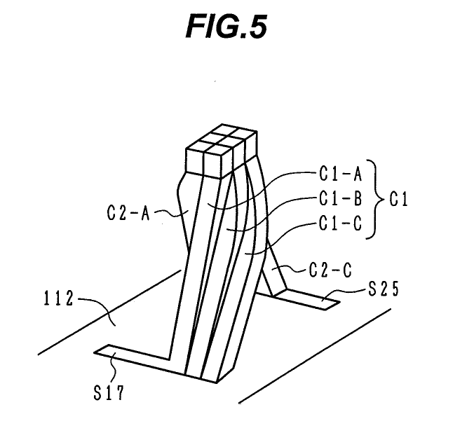

FIG. 3 is an expansion plan view showing the configuration of the stator used for the rotating electric machine according to the first embodiment of the present invention. FIG. 4 is a perspective view showing the configuration of a stator coil used for the rotating electric machine according to the first embodiment of the present invention. FIG. 5 is a perspective view showing the configuration of an essential part of the stator used for the rotating electric machine according to the first embodiment of the present invention.

FIG. 3 shows a state of the stator 110 circumferentially expanded wherein the stator coils 114 are inserted into the stator slots 112S of the stator core 112. Although each stator coil 114 includes three phase coils (U-, V-, and W-phase coils), FIG. 3 shows only one phase coil, for example, the U-phase coil.

The stator core 112 includes a total of 48 slots: S1 to S48. Two stator coils are inserted into each slot. As a conducting wire of a stator coil 114, a rectangular wire having a rectangular cross-sectional profile and covered with insulating coating is used. The rectangular wire is formed in a U shape to form a conducting wire. Two ends of the U-shaped rectangular wire are inserted into two different slots. More specifically, each of the two ends of the rectangular wire is inserted from one end face of each of the two slots. At other end face of each slot, each end of the rectangular wire is connected through welding with one end of another conducting wire protruded from another slot.

Specifically, referring to FIG. 3, one end of a U-shaped conducting wire C1 is inserted from the lower part of the core 112 into a slot S8, and the other end of the U-shaped conducting wire C1 is inserted into a slot S17. Further, one end of a U-shaped conducting wire C2 is inserted into a slot S25, and the other end of the U-shaped conducting wire C2 is inserted into a slot S34. Then, above the stator core 12, the end of the conducting wire C1 inserted into the slot S17 is connected through welding with the end of the conducting wire C2 inserted into the slot S25. The above-mentioned process is repeated so that the stator coils 114 are wound around the stator core 112 in the form of series distributed winding.

The present embodiment is characterized firstly in that the one conducting wire described above is constructed of a plurality of rectangular wires connected in parallel through a plurality of connections, and secondly in the way of arrangement of the plurality of rectangular wires.

As shown in FIG. 4, the one conducting wire C1 shown in FIG. 3 is composed of three rectangular wires C1-A, C1-B, and C1-C. While a conventional stator coil uses one rectangular wire, a stator coil according to the present embodiment uses three rectangular wires connected in parallel. For example, while the cross-sectional profile of one conventional rectangular wire is a rectangle having a long side of 8 mm and a short side of 2 mm, the cross-sectional profile of a rectangular wire according to the present embodiment is a rectangle having a long side of 2.66 mm and a short side of 2 mm. The cross-section area of the three rectangular wires connected in parallel according to the present invention is the same as that of the one conventional rectangular wire, resulting in the same electric resistance.

As shown in FIG. 4, one ends of the three rectangular wires C1-A, C1-B, and C1-C are inserted into the closed slot S8 of the stator core 112, and the other ends are inserted into the closed slot S17.

With the present embodiment, inside a slot S, the rectangular wires C1-A, C1-B, and C1-C are arranged in a row in the radial direction of the stator (direction of an arrow A, that is, radial direction of the slot S) such that short sides of the three rectangular wires are in contact with each other. Therefore, the width W of the three rectangular wires C1-A, C1-B, and C1-C bundled together in a slot equals 8 mm which is the same as the width of one conventional rectangular wire (having a long side of 8 mm and a short side of 2 mm) inserted in a slot.

At a coil end, however, the rectangular wires C1-A, C1-B, and C1-C are arranged in a row in the circumferential direction of the stator (direction of an arrow B) such that long sides of the three rectangular wires are in contact with each other. As a result, as shown in FIG. 4, the width of the coil at the coil end equals the width of one rectangular wire, i.e., 2.66 mm. When one conventional rectangular wire is used, the width of the coil at the coil end is 8 mm. Therefore, the axial length of the stator at the coil end can be shortened by 5.34 mm, i.e., from 8 mm in a conventional stator to 2.66 mm in a stator according to the present embodiment.

Specifically, when N rectangular wires connected in parallel are used instead of one conventional rectangular wire having a width W, and when the plurality of rectangular wires are arranged in the circumferential direction of the stator at the coil end, the width of the coil at the coil end equals W/N that can reduce the coil length at the coil end by (W−(W/N)).

Welding connection of the other ends will explained below with reference to FIG. 5. As shown in FIG. 5, one ends of the first three rectangular wires C1-A, C1-B, and C1-C are protruded from the slot S17 of the stator core 112. Further, one ends of second three rectangular wires C2 (C2-A, C2-B, and C2-C) are protruded from the slot S25 of the stator core 112. These six rectangular wires are bundled together and subjected to electric connection through TIG welding or the like. Since insulating coating such as an enamel coating is formed on the surface of each of the plurality of rectangular wires, the insulating coating at the end of each rectangular wire is removed prior to TIG welding.

In accordance with the present embodiment as mentioned above, the length of the coil end can be reduced to shorten the axial length of the rotating electric machine, thus downsizing the rotating electric machine. Further, the use of a plurality of rectangular wires connected in parallel instead of one conventional rectangular wire can increase the total surface area of the rectangular wires, resulting in improvement in heat radiation from coil ends.

The use of three rectangular wires connected in parallel instead of one conventional rectangular wire can increase the surface area. Therefore, a current flowing on the surface can be increased making it possible to reduce high-frequency copper loss due to the skin effect.

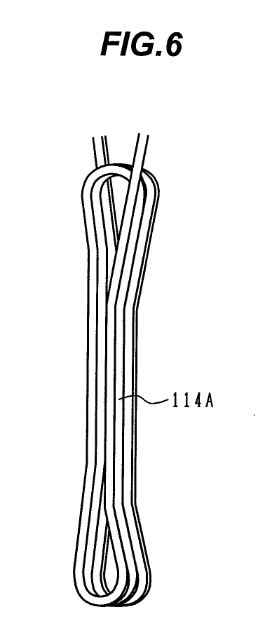

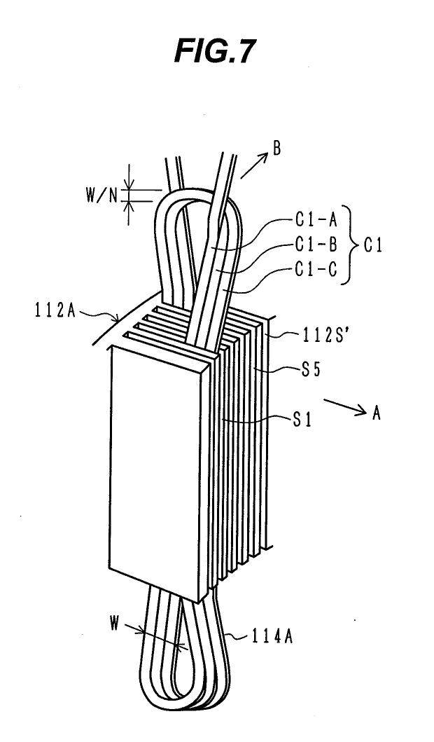

The configuration of a rotating electric machine according to a second embodiment of the present invention will be explained below with reference to FIGS. 6 and 7. The overall configuration of the rotating electric machine according to the present embodiment is the same as that of FIGS. 1 and 2.

FIG. 6 is a perspective view showing the configuration of a stator coil used for the rotating electric machine according to the second embodiment of the present invention. FIG. 7 is a perspective view showing the configuration of an essential part of a stator used for the rotating electric machine according to the second embodiment of the present invention.

As shown in FIG. 6, a rectangular wire having a rectangular cross-sectional profile is used as the conducting wire of a stator coil 114A. The rectangular wire is formed in a predetermined annular shape (referred to as formed coil). In the example shown in FIG. 6, the rectangular wire is wound in an annular shape by three turns.

With the present embodiment, as shown in FIG. 7, the inner circumferential side of each stator slot 112S′ of the stator core 112A is open to the rotor (open slot). Then, the stator coil 114A is inserted from the open portion on the inner circumferential side of the stator slot 112S′.

Similar to the stator shown in FIG. 2, the stator is provided with 48 stator slots 112S′. One straight portion of the stator coil 114A is inserted into a slot S1, and the other straight portion is inserted into a slot S5 which is a fifth slot from the slot S1. In this way, the stator coil 114A (formed coil) is wound around the stator teeth in the form of parallel distributed winding.

As shown in FIG. 7, the conducting wire C1 inserted into a slot is composed of three rectangular wires C1-A, C1-B, and C1-C having the same cross-section area as one conventional rectangular wire. With the present embodiment, inside a slot S, the rectangular wires C1-A, C1-B, and C1-C are arranged in a row in the radial direction of the stator (direction of an arrow A, that is, radial direction of the slot S) such that short sides of the three rectangular wires are in contact with each other. Therefore, the width W of the three rectangular wires C1-A, C1-B, and C1-C bundled together in the slot equals 8 mm which is the same as the width of one conventional rectangular wire (having a long side of 8 mm and a short side of 2 mm) inserted in the slot.

At a coil end, however, the rectangular wires C1-A, C1-B, and C1-C are arranged in a row in the circumferential direction of the stator (direction of an arrow B) such that long sides of the three rectangular wires are in contact with each other. As a result, the width of the coil at the coil end equals the width of one rectangular wire, i.e., 2.66 mm. When one conventional rectangular wire is used, the width of the coil at the coil end is 8 mm. Therefore, the axial length of the stator at the coil end can be shortened by 5.34 mm, i.e., from 8 mm in a conventional stator to 2.66 mm in a stator according to the present embodiment.

Specifically, when N rectangular wires connected in parallel are used instead of one conventional rectangular wire having a width W, and when the plurality of rectangular wires are arranged in the circumferential direction of the stator, the width of the coil at the coil end equals W/N that can reduce the coil length at the coil end by (W−(W/N)).

In accordance with the present embodiment as mentioned above, the length of the coil end can be reduced to shorten the axial length of the rotating electric machine, thus downsizing the rotating electric machine. Further, the use of a plurality of rectangular wires connected in parallel instead of one conventional rectangular wire can increase the total surface area of the rectangular wires, resulting in improvement in heat radiation from coil ends.

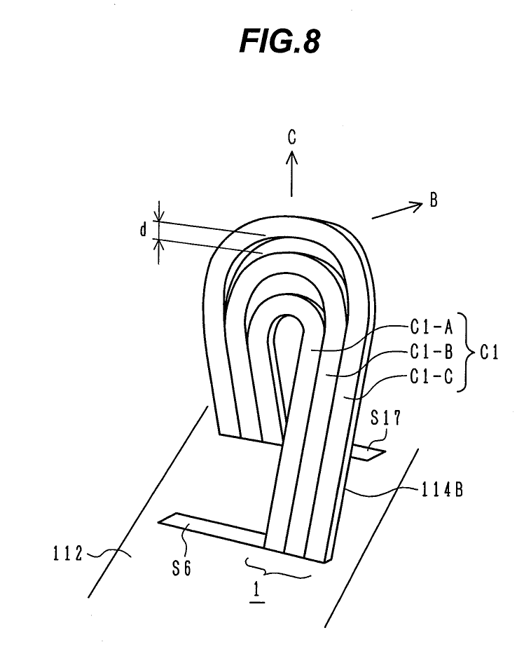

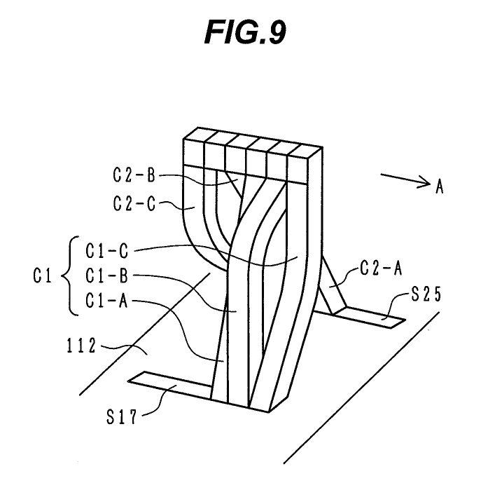

The configuration of a rotating electric machine according to a third embodiment of the present invention will be explained below with reference to FIGS. 8 and 9. The overall configuration of the rotating electric machine according to the present embodiment is the same as that of FIGS. 1 and 2.

FIG. 8 is a perspective view showing the configuration of a stator coil used for the rotating electric machine according to the third embodiment of the present invention. FIG. 9 is a perspective view showing the configuration of an essential part of a stator used for the rotating electric machine according to the third embodiment of the present invention.

The present embodiment is applied to the closed slot of FIGS. 4 and 5. A stator coil 114B is wound around the stator core 112 in the form of series distributed winding.

As shown in FIG. 8, one conducting wire C1 is composed of three rectangular wires C1-A, C1-B, and C1-C. While a conventional stator coil uses one rectangular wire, a stator coil according to the present embodiment uses three rectangular wires connected in parallel. For example, while the cross-sectional profile of one conventional rectangular wire is a rectangle having a long side of 8 mm and a short side of 2 mm, the cross-sectional profile of the rectangular wire according to the present embodiment is a rectangle having a long side of 2.66 mm and a short side of 2 mm. The cross-section area of three rectangular wires connected in parallel according to the present invention is the same as that of one conventional rectangular wire, resulting in the same electric resistance.

As shown in FIG. 4, one ends of the three rectangular wires C1-A, C1-B, and C1-C are inserted into the closed slot S8 of the stator core 112, and the other ends are inserted into the closed slot S17.

With the present embodiment, inside a slot S, the rectangular wires C1-A, C1-B, and C1-C are arranged in a row in the radial direction of the stator (direction of an arrow A, that is, radial direction of the slot S) such that short sides of the three rectangular wires are in contact with each other. Therefore, the width W of the three rectangular wires C1-A, C1-B, and C1-C bundled together in the slot equals 8 mm which is the same as the width of one conventional rectangular wire (having a long side of 8 mm and a short side of 2 mm) inserted in the slot.

As shown in FIG. 8, the rectangular wires of the upper and lower coils are arranged in reverse in the radial direction of the stator; at the coil end formed through bending, the rectangular wires are disposed so as to be spaced apart from each other with a gap d therebetween in the axial direction of the stator (direction of an arrow C).

In this way, since the surface area of the rectangular wires at the coil end is increased and a coolant passes through gaps between the rectangular wires, heat radiation from coil ends on the connection side is improved.

Welding connection of the other ends will be explained below with reference to FIG. 9. As shown in FIG. 9, one ends of first three rectangular wires C1-A, C1-B, and C1-C are protruded from the slot S17 of the stator core 112. Further, one ends of second three rectangular wires C2 (C2-A, C2-B, and C2-C) are protruded from the slot S25 of the stator core 112. These six rectangular wires are bundled together and subjected to electric connection through TIG welding or the like. Since insulating coating such as an enamel coating is formed on the surface of each of the plurality of rectangular wires, the insulating coating at the end of each rectangular wire is removed prior to TIG welding.

The open ends of the rectangular wires protruded from the end face of the stator are arranged so as not to be circumferentially overlapped with each other when viewed from the radial direction (direction of an arrow A) by providing a different length (path) from a slot to the end for each wire.

As a result, since the surface area of the rectangular wires at the coil end is increased, and a coolant passes through gaps between the rectangular wires formed between each slot and the connecting portion, heat radiation from coil ends on the connection side is improved.

In accordance with the present embodiment as mentioned above, the use of a plurality of rectangular wires instead of one conventional rectangular wire can increase the total surface area of the rectangular wires, resulting in improvement in heat radiation from coil ends. Further, at the coil end, a gap formed between adjacent rectangular wires further improves heat radiation.

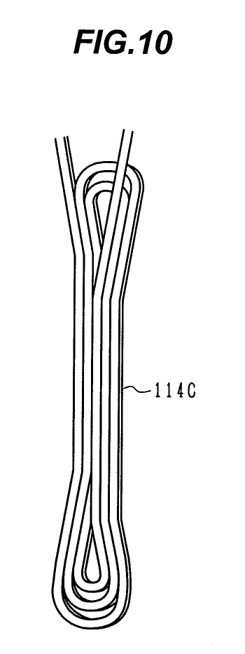

The configuration of a rotating electric machine according to a fourth embodiment of the present invention will be explained below with reference to FIG. 10. The overall configuration of the rotating electric machine according to the present embodiment is the same as that of FIGS. 1 and 2.

FIG. 10 is a perspective view showing the configuration of a stator coil used for the rotating electric machine according to the fourth embodiment of the present invention.

The present embodiment is applied to the open slot explained in FIG. 7. A stator coil 114C is wound around the stator core in the form of parallel distributed winding.

Similar to FIG. 6, a rectangular wire having a rectangular cross section is used as the conducting wire of the stator coil 114C. The rectangular wire is formed in a predetermined annular shape (referred to as formed coil). In the example shown in FIG. 10, the rectangular wire is wound in an annular shape by three turns.

Similar to the example of FIG. 6, the conducting wire C1 inserted into a slot is composed of three rectangular wires having the same cross-section area as one conventional rectangular wire. As shown in FIG. 7, the rectangular wires are arranged in a row in the radial direction of the stator (radial direction of the slot) and then inserted into the slot such that short sides of the three rectangular wires are in contact with each other.

At a coil end, however, the rectangular wires are disposed so as to be spaced apart from each other with a gap therebetween in the axial direction of the stator. In this way, since the surface area of the rectangular wires at the coil end is increased and a coolant passes through gaps between the rectangular wires, heat radiation from coil ends on the connection side is improved.

In accordance with the present embodiment as mentioned above, the use of a plurality of rectangular wires instead of one conventional rectangular wire can increase the total surface area of the rectangular wires, resulting in improvement in heat radiation from coil ends. Further, at the coil end, a gap formed between adjacent rectangular wires further improves heat radiation.

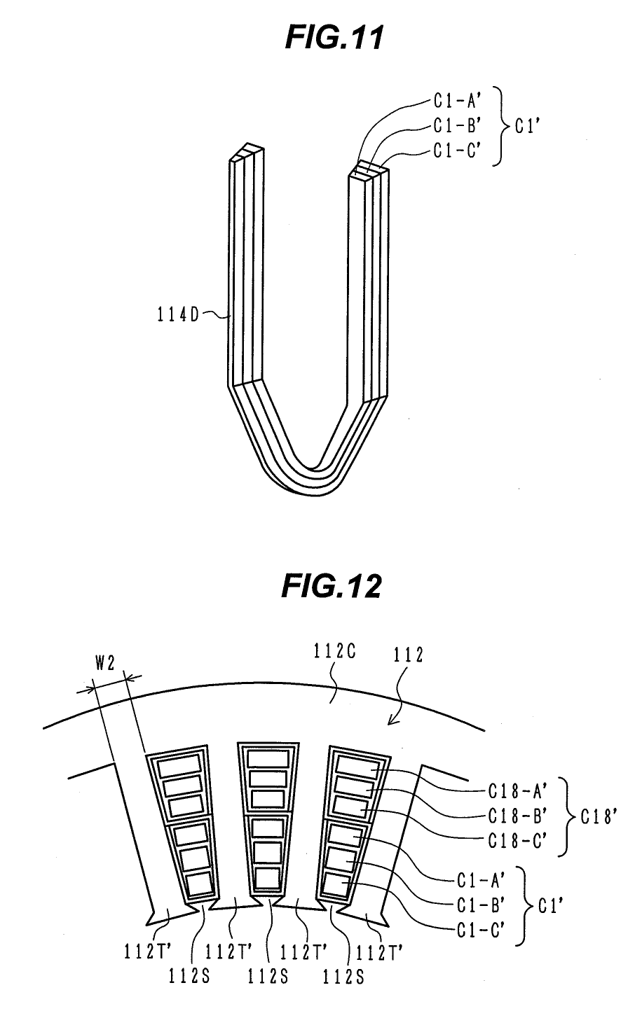

The configuration of a rotating electric machine according to a fifth embodiment of the present invention will be explained below with reference to FIGS. 11 and 12. The overall configuration of the rotating electric machine according to the present embodiment is the same as that of FIGS. 1 and 2.

FIG. 11 is a perspective view showing the configuration of a stator coil used for the rotating electric machine according to the fifth embodiment of the present invention. FIG. 12 is a plan view showing the configuration of an essential part of a stator used for the rotating electric machine according to the fifth embodiment of the present invention.

The present embodiment is applied to the open slot explained in FIG. 7. A stator coil 114D is wound around the stator core in the form of parallel distributed winding.

As shown in FIG. 11, the conducting wire constituting the stator coil 114D is composed of three rectangular wires: C1-A′, C1-B′, and C1-C′. Further, the three rectangular wires are provide such that a rectangular wire disposed on the outer circumferential side of a slot has a larger circumferential width and the cross-sectional profile of the rectangular wires is approximated to the slot profile.

FIG. 12 shows a state where the stator coil 114D is inserted into stator slots 112S. Here, stator teeth 112T′ have the same width W2 at any radial position of the teeth. As a result, the width of each stator slot 112S becomes smaller on the inner circumferential side and larger on the outer circumferential side. As explained in FIG. 11, a rectangular wire disposed on the outer circumferential side of the slot has a larger circumferential width. This makes the cross-sectional profile of the rectangular wires approximate to the slot profile. The width of the upper coil (a coil disposed at the outer circumferential side of the stator slot) is made larger than the width of the lower coil (a coil disposed at the inner circumferential side of the stator slot). This makes the cross-sectional profile of the rectangular wires approximate to the slot profile.

Here, when a coil is configured with rectangular wires having the same cross-sectional profile, the stator slot has a rectangular shape and therefore each of teeth 9 has a larger width on the outer circumferential side. However, since a magnetic path width necessary to satisfy the required performance of the rotating electric machine is the teeth width on the inner circumferential side, the core used on the outer circumferential side is excessive.

On the contrary, with the coil structure as shown in FIG. 11, the slot profile can be made in a trapezoid shape and accordingly the teeth width can be equalized allowing coils to be mounted in higher density. This structure is effective for obtaining the rotating electric machine with downsizing and higher power.

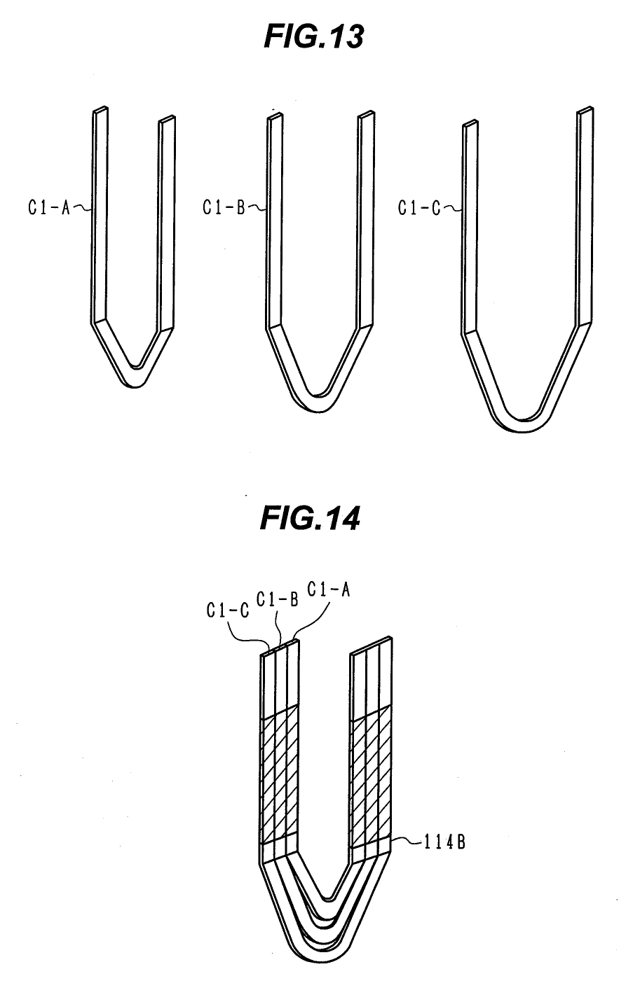

The configuration of a rotating electric machine according to a sixth embodiment of the present invention will be explained below with reference to FIGS. 13 and 14. The overall configuration of the rotating electric machine according to the present embodiment is the same as that of FIGS. 1 and 2.

FIGS. 13 and 14 are perspective views showing the configuration of a stator coil used for the rotating electric machine according to the sixth embodiment of the present invention.

The present embodiment is applied to the closed slot explained in FIG. 8. The stator coil 114B is wound around the stator core in the form of series distributed winding.

As shown in FIG. 13, the stator coil is composed of three rectangular wires: C1-A, C1-B, and C1-C. Here, when these rectangular wires are separated, it is difficult to assemble the core and coils.

As shown in FIG. 14, the slot insertion portions of the rectangular wires C1-A, C1-B, and C1-C formed through U-shape bending are arranged in a row, and only the rectangular wires at the slot insertion portions are bonded as shown by hatching. The slot insertion portions are bonded either by (1) using self-fusing wires as rectangular wires and heating only the slot insertion portions to attain self-bonding or by (2) applying insulated paper or insulated film, etc. having a fusing layer to the slot insertion portions to attain bonding.

Then, the two slot insertion pieces are grasped and then opened in the circumferential direction of the stator, thus obtaining a stator coil for series wave winding. Only the slot insertion portions of the coil formed by arranging the rectangular wires in a row are bonded, and then the two slot insertion pieces are grasped and opened in the circumferential direction of the stator, thus obtaining a stator coil for parallel winding.

As explained above, the slot insertion portions are bonded to improve heat transmission between the rectangular wires and heat transmission from the coil inside the slot to the stator core resulting in improved heat radiation of the coil. Further, since a plurality of rectangular wires can be handled as one coil wire, it becomes easier to assemble the core and coils.

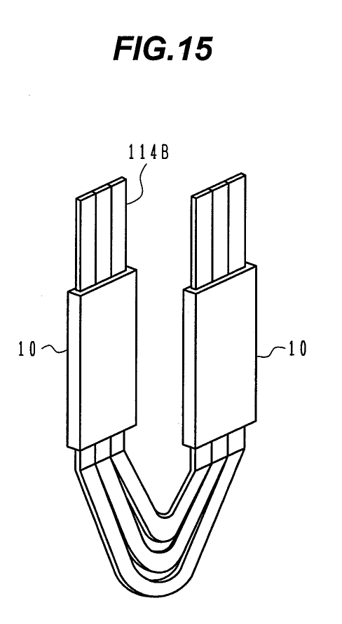

The configuration of a rotating electric machine according to a seventh embodiment of the present invention will be explained below with reference to FIG. 15. The overall configuration of the rotating electric machine according to the present embodiment is the same as that of FIGS. 1 and 2.

FIG. 15 is a perspective view showing the configuration of a stator coil used for the rotating electric machine according to the seventh embodiment of the present invention.

The present embodiment is applied to the closed slot explained in FIG. 8. The stator coil 114B is wound around the stator core in the form of series distributed winding.

In the present embodiment, the slot insertion portions of the three rectangular wires are unified such that the slot insertion portions are wrapped with a mold block, and then resin is poured into the mold block to mold the resin in a cross-sectional profile slightly smaller than the cross-sectional profile of a slot, resulting in formation of a resin-molded portion 10.

Also in accordance with the present embodiment, the slot insertion portions are bonded to improve heat transmission between the rectangular wires and heat transmission from the coil inside the slot to the stator core resulting in improved heat radiation of the coil. Further, since a plurality of rectangular wires can be handled as one coil wire, it becomes easier to assemble the core and coils.

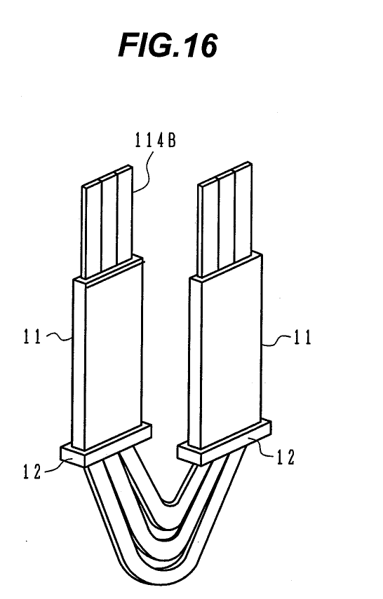

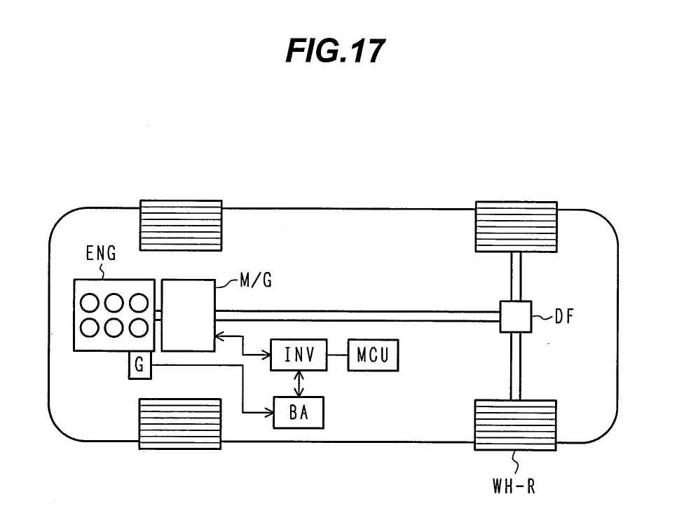

The configuration of a rotating electric machine according to an eighth embodiment of the present invention will be explained below with reference to FIG. 16. The overall configuration of the rotating electric machine according to the present embodiment is the same as that of FIGS. 1 and 2.

FIG. 16 is a perspective view showing the configuration of a stator coil used for the rotating electric machine according to the eighth embodiment of the present invention.

The present embodiment is applied to the closed slot explained in FIG. 8. The stator coil 114B is wound around the stator core in the form of series distributed winding.

In the present embodiment, as the same way as the example of FIG. 15, the slot insertion portion of the three rectangular wires are unified using the resin-mold portion 10, and a thick portion 12 for protecting a portion at which the coil wires rise from the core end face is provided integrally with the resin-mold portion 11.

This method provides a higher strength than the insulated paper conventionally used. Therefore, even when the bending radius of the portion at which the coil wires rise from the slot is decreased to form the coil end low, the insulation between the core and the coil can be ensured.

The present embodiment can be applied only to the coil end on the side bended in a U shape in the closed-slot stator coil type, and applied to both coil ends in the open-slot stator coil type.

Also in accordance with the present embodiment, the slot insertion portions are bonded to improve heat transmission between the rectangular wires and heat transmission from the coil inside the slot to the stator core resulting in improved heat radiation of the coil. Further, since a plurality of rectangular wires can be handled as one coil wire, it becomes easier to assemble the core and coils. Further, the insulation between the core and the coil can be ensured even when the coil end is formed low.

The configuration of a hybrid vehicle mounting a rotating electric machine according to each embodiment of the present invention will be explained below with reference to FIG. 17.

FIG. 17 is a block diagram showing the configuration of the hybrid vehicle mounting the rotating electric machine according to each embodiment of the present invention.

The hybrid vehicle includes an engine ENG and a rotating electric machine (motor generator (M/G)) as sources of driving force. The motor generator M/G has the configuration explained in FIGS. 1 to 16. The driving force of the engine ENG and the motor generator M/G is transmitted to rear wheels WH-R through a gearbox (not shown) and a differential gear DF to drive the rear wheels WH-R. The engine ENG drives a generator G. The electric power generated by the generator G is accumulated in a battery BA. The electric power of the battery BA is converted to three-phase AC electric power by an inverter INV and then supplied to the motor generator M/G. The inverter INV is controlled by a motor control unit MCU.

The hybrid vehicle of the present embodiment is provided with an idle stop mechanism which stops the engine ENG when the vehicle stops at a crossing or the like. When the vehicle runs again and the amount of accelerator depression, etc. is detected, the motor control unit MCU controls the inverter INV to operate the motor generator M/G as a motor to rotate the wheels by the driving force, and restarts the engine ENG. After the engine ENG is restarted, the motor generator M/G stops. Further, at the time of deceleration, etc., the motor control unit MCU controls the inverter INV to operate the motor generator M/G as a generator, converts the generated electric power to DC electric power, and accumulates the DC electric power in the battery BA.

As mentioned above, since the rotating electric machine according to the present embodiment is compact and highly efficient, the fuel consumption of the hybrid vehicle can be reduced.

1. A rotating electric machine comprising:
a stator; and
a rotor disposed opposing said stator through a gap and held rotatably;
wherein said stator comprises a stator core, and stator coils inserted into stator slots formed between a plurality of stator teeth formed on the stator core, the stator coils being wound around the stator teeth in the form of distributed winding,
each stator coil includes a plurality of rectangular wires having insulating coating,
the plurality of rectangular wires are inserted into the one stator slot, and
the direction of arrangement of the plurality of rectangular wires in the stator slot is different from that of the plurality of rectangular wires at both coil ends outside the stator slot.

2. The rotating electric machine according to claim 1,
wherein the plurality of rectangular wires in the stator slot are arranged in the radial direction of the rotating electric machine such that the rectangular wires are in contact with each other, and
wherein the plurality of rectangular wires at the coil end are arranged in the circumferential direction of the rotating electric machine such that the rectangular wires are in contact with each other.

3. The rotating electric machine according to claim 2,
wherein the stator slot is a closed slot, and
wherein the rectangular wires formed in a U shape are inserted from one end face of the stator slot and then connected with other rectangular wires protruded from an adjacent stator slot at the other end face of the stator slot to form a series wave winding.

4. The rotating electric machine according to claim 2,
wherein the stator slot is an open slot, and
wherein the rectangular wires are formed in a predetermined annular shape to configure a formed coil in advance, and the formed coil is inserted from an open portion of the stator slot to form a parallel winding.

5. The rotating electric machine according to claim 1,
wherein the plurality of rectangular wires in the stator slot are arranged in the radial direction of the rotating electric machine such that the rectangular wires are in contact with each other, and
wherein the plurality of rectangular wires at the coil end are arranged in the axial direction of the rotating electric machine such that the rectangular wires are spaced apart from each other.

6. The rotating electric machine according to claim 5,
wherein the stator slot is a closed slot, and
wherein the rectangular wires formed in a U shape are inserted from one end face of the stator slot and then connected with other rectangular wires protruded from an adjacent stator slot at the other end face of the stator slot to form a series wave winding.

7. The rotating electric machine according to claim 5,
wherein the stator slot is an open slot, and
wherein the rectangular wires are formed in a predetermined annular shape to configure a formed coil in advance, and the formed coil is inserted from an open portion of the stator slot to form a parallel winding.

8. The rotating electric machine according to claim 1,
wherein the plurality of rectangular wires are connected in parallel.

9. The rotating electric machine according to claim 1,
wherein the stator teeth have the same radial width, and
wherein each of the plurality of rectangular wires inserted into the stator slot has the circumferential width, on the side closer to said rotor, smaller than that of a rectangular wire on the side further from said rotor.

10. The rotating electric machine according to claim 3,
wherein the rectangular wires formed in a U shape are provided with a bonded portion where the plurality of rectangular wires are bonded with each other and inserted into the stator slot.

11. The rotating electric machine according to claim 10,
wherein the bonded portion is a resin-mold portion.

12. The rotating electric machine according to claim 11,
wherein the bonded portion is disposed integrally with the resin-mold portion and provided with a thick portion for protecting a portion at which coil wires rise from the core end face.
